(19) United States
(12) Patent Application Publication
(10) Pub. No.: US 2024/0386808 A1
(43) Pub. Date: Nov. 21, 2024

(54) PHYSICAL AND VIRTUAL TASK SUPPORT AND ASSISTANCE SYSTEM

(71) Applicant: New Forge Tech Inc., Fort Mill, SC (US)

(72) Inventor: Javier Ortiz, New Bern, NC (US)

(73) Assignee: New Forge Tech Inc., Fort Mill, SC (US)

(21) Appl. No.: 18/667,276

(22) Filed: May 17, 2024

Related U.S. Application Data
(60) Provisional application No. 63/503,295, filed on May 19, 2023.

(51) Int. Cl. G09B 5/14; G09B 19/00

(52) U.S. Cl. CPC G09B 5/14; G09B 19/00

(57) ABSTRACT

The present invention relates to a system that utilizes augmented reality and artificial intelligence to provide users with expert-sourced information and real-time assistance for completing various tasks comprising: a first computer device in communications with a data storage system; a set of computer readable instructions that when processed by the computer device is adapted to: receive a query representing a task for which instructions are desired; retrieve from the data storage system information according to the query; produce instructions according to the information retrieved; format the instructions to allow the instructions to be displayed on an augmented reality device; and transmit the instructions to a second computing device.

### PRIOR APPLICATIONS

This application claim priority on U.S. Provisional Patent Application Ser. No. 63/503,295 filed May 19, 2023, and incorporated by reference.

### BACKGROUND OF THE INVENTION

### 1) Field of the Invention

The present invention relates to a system that utilizes augmented reality and artificial intelligence (AI) and/or machine learning to provide users with expert-sourced information and real-time assistance for completing various tasks.

### 2) Description of Related Art

When faced with a task that the user does not know how to complete or otherwise needs assistance in its completion, the user is typically left with a few options that include finding the necessary information on his or her own or hiring someone who knows how to complete the task and receiving assistance. While the advent of the online resources using a global computer network has made finding the necessary information easier, there are still many cases where the user cannot find the necessary information needed, the information is incomplete or even incorrect, is not specific to the user's task and fails to address unique situations or problems encountered while doing the task.

Accordingly, it is an object of the present invention to provide a system that can provide a tailored set of task completion instructions based upon discrete sources of information and can provide remote assistance from a live expert using augmented reality in the task field.

It is an object of the present invention to provide a system that allows for crowd-sourced information to be uploaded to a database and for an algorithm to receive an inquiry regarding a specific task and in response to the inquiry to use the crowd-sourced information to automatically produce instructions according to the topic of the inquiry and the information available in the database.

It is an object of the present invention to provide a system that allows a user to remotely connect to an expert such that information can be transmitted between the user and the expert using computing devices capable of capturing, transmitting and receiving audio and video information, such as smart glasses, smart phones, headsets, and the like, thus allowing the user and expert to interact through a global communication network and augmented reality.

### SUMMARY OF THE INVENTION

The above objectives are accomplished according to the present invention by providing a physical and virtual task support and assistance system comprising: a mobile device adapted to capture an image of a component associated with a task, transmit the task to an instructional system, receive content associated with the task from the instructional system and display the content on the mobile device; wherein the instructional system is adapted to access a dataset that includes content associated with the task, receive component information, receive task information, retrieve from the dataset an instruction for completing the task, transmit the instruction to the mobile device, receive a task status, complete a task order according to the task status being complete, establish a connection with a remote computer system according to a task status being attempted-incomplete; and, wherein the remote computer system is in communications with the mobile device and adapted to receive the image from the mobile device, display the image, receive a notation to the image, transmit the notation to the mobile device.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a diagram of aspects of the present invention;

FIG. 2 shows a schematic of aspects of the present invention;

FIG. 3 shows a schematic of aspects of the present invention;

FIG. 4 shows a perspective view of aspects of the present invention;

FIG. 5A shows a perspective view of aspects of the present invention;

FIG. 5B shows a perspective view of aspects of the present invention;

FIG. 5C shows a perspective view of aspects of the present invention; and,

FIG. 6 shows a schematic of aspects of the present invention.

### DETAILED DESCRIPTION OF A PREFERRED EMBODIMENT

With reference to the drawings, the invention will now be described in more

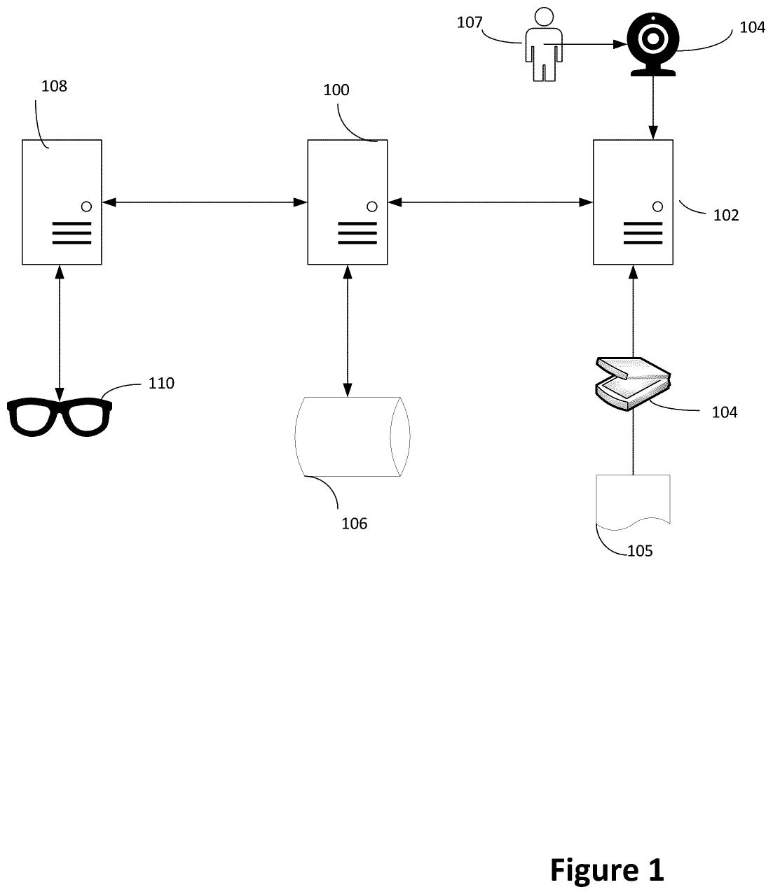

detail. Referring now to FIG. 1, an instructions system 100 is in electronic communication with a first computing device 102 that may be used by an industry expert to upload information regarding specific tasks that are commonly encountered within a particular industry. In one embodiment, the information in the instructions system can be deposited by a professional in the industry such as an experienced technician and the like. By way of example, the professional can be a HVAC repair technician with substantial experience and training. Using this knowledge, the repair technician can upload content that can include text, video and audio that addresses common issues with the repair of HVAC units. This information can be stored in the instructions system.

In one embodiment, the content can be reviewed by others in the industry with educational, knowledge and experience that can provide a review as to the quality of the content placed on the instructions system by the industry expert (e.g., repair technician). The instructional system can be accessed by a user that wishes to review the content for a particular task, for example, the repair of an HVAC unit. In this case, the user would access the instructional system using electronic communications and query a task such as the HVAC unit is not cooling. In response, the instructional system may inform the user that some aspects of the system should be checked and analyzed. For example, using the HVAC by way of example, the user may be instructed to check the condenser coils for dirt, debris, and other pollutants which can degrade performance. Electronic communications could be wired, wireless, secure encrypted, local area network area network, mesh or any other means or methods generally known in the industry.

The information stored by the instructional system could be stored on first computing device 102 on a remote computer system accessible by the internet or in the cloud or it could be a physical document 105 that could be loaded onto first computing device by way of a capture device 104. The information could also be a video that either already exists (whether on the first computing device 102, a third-party server, the internet and/or the cloud) or is created by the industry expert 107 by way of the capture device, which could be a camera in communication with the first computing device 102. Alternatively, the capture device 104 could comprise a mobile device and/or an augmented reality device such as smart glasses having the capability of recording the user's narrations, viewpoint, and video augmentations. The first computing device may transmit the information to the instructions system 100, which then transcribes any video submissions and indexes and stores such information in a database in a searchable format such as optical character recognition or any other formats that are generally known in the industry. Information that is provided may be used by the instructions system to create and/or predict instructions for the task at hand and/or can be provided directly to a user in response to a search query.

The instructions system may also be in communications with a second computing device 108, that may be used by a user seeking instructions on a particular task to be completed. Using a display, application programming interface, graphic user interface or the like, the instructions system may prompt the user to input an instruction query representing a search for the type of task to be completed and/or the instructions for which the user is looking (e.g., poor performance of an HVAC). Upon receiving the query, the instructions system 100 will identify key terms and concepts and will conduct a search of the information residing in database 106 for any information that may be relevant to the query. The database could be cloud based or any other storage platform or system generally known in the industry. Using a natural language model artificial intelligence designed to produce human-like text the instructions system 100 will use the information revealed by the search to create or predict a set of instructions on how to complete the task identified in the query. For example, in the case where the task is to correct the poor performance of a HVAC unit, the instructional system can inform the user to check the airflow, thermostat, drain lines, refrigerant levels, condenser coils, evaporator coils, air handler, electrical operation (e.g., short cycling), fuses, breakers, batteries, wiring, electrical components and the like. The instructional system can provide an order of priority according to the request made by the user. For example, the user may request assistance with an HVAC unit that is not cooling. The instructional system may reply to first check refrigerant levels.

In one embodiment, the instructional system can request additional information such as the make, brand, model, year, and other information associated with the task requested by the user. This information can be used to refine the information that is presented to the user. For example, in the case of an HVAC, after the year 2020 the refrigerant R-22 can no longer be used and the instructional system may report to the user that the HVAC unit needs to be replaced, retrofitted, or rely upon R-22 stockpiles or reclaimed refrigerant. Understanding the components associated with a task can modify the response provided by the instructional system.

In one embodiment, the mobile device can use image recognition to determine information relevant to the task. For example, in the HVAC example, the housing of the HVAC unit can indicate its brand. Using image recognition, the mobile device can provide of suggest the make, model brand and the like of components that are associated with the task as hand. The user can override this information as necessary. The mobile device can also capture information from labels, plates, and the like that are associated with the components that are associated with the task. For example, the mobile device can capture a compressor label shown in Table 1 and determine from the label the model number, volts, phase, and other information.

TABLE 1

| MODEL NO./ | | | | MFD./FAB |
|---|---|---|---|---|
| 08/2012 | | | | |
| MODÈLE NO. | RAWL-090DAZ | | | |
| SERIAL NO./ | | | | |
| | | OUTDOOR USE/ | | |
| NO. DE SÈRIE | 7754F3112026 | | | USAGE |
| ÈXTÈRIEUR | | | | |
| VOLTS | 460 | PHASE | 3 | HERTZ 60 |

| COMPRESSOR (EACH)/ | R.L.A. | 12.2 | L.R.A. 100 |
|---|---|---|---|
| COMPRESSOR (CHAQUE) | | | |
| OUTDOOR FAN MOTOR (EACH)/ | F.L.A. | 1.3 | HP. 1/3 |
| MOTEUR VENTIL. EXT. (CHAQUE) | | | |
| MIN. SUPPLY CIRCUIT AMPACITY/ | | 17 | AMP |
| COURANT ADMISSIBLE D'ALIM. MIN. | | | |
| MAX. FUSE OR CKT. BRK. SIZE*/ | | 25 | AMP |
| CAL. MAX. DE FUSIBLE/DISJ* | | | |
| MIN. FUSE OR CKT. BRK. SIZE*/ | | 20 | AMP |
| CAL. MAX. DE FUSIBLE/DISJ* | | | |
| DESIGN PRESSURE HIGH/ | 450 PSIG/3103 kPa | | |
| PRESSION NOMINALE HAUTE | | | |
| DESIGN PRESSURE LOW/ | 250 PSIG/1724 kPa | | |
| PRESSION NOMINALE BASSE | | | |
| TOTAL SYSTEM CHARGE/ | | | |
| CHARGE TOTALE SYSTEME | | | |
| R410A | | | |

SEE INSTRUCTIONS INSIDE ACCESS PANEL.
VOIR INSTRUCTIONS DANS LE PANNEAU D'ACCÈS
RHEEM AIR CONDITIONING DIVISION
FORTH SMITH, ARKANSAS
ASSEMBLED IN USA
*HACR TYPE BREAKER FOR U.S.A./DISJONCENTEUR DIFFERENTIEL

This can be used by the AI algorithm and/or machine learning engine to discover, retrieve and present content to the user for the assigned task (e.g., repair the compressor of a HVAC unit). In this example, the Al algorithm and/or machine learning engine can use the model number, search the database, and determine that the compressor is associated with Rheem 11.2-EER R-410A Commercial High-Efficiency Condensing Unit Split System Air Conditioners, 7.5 Ton, 90000 BtuH and provide this information to the user.

The instructional system 100 can transmit the instructions to the user via the second computing device 108. The instructional system then prompts the user to review, edit and/or provide feedback on the instructions received. The instructional system 100 may then use this feedback to update the information in database 106 and to further teach the AI algorithm and/or machine learning engine. For example, the instructional system may state in the case of an HVAC repair that the condensation coils should be cleaned. However, users report that this task does little to impact the cooling ability of the HVAC unit. Therefore, based upon the users' feedback and input, the instructional system then reduces the priority of instructions for cleaning the condensation coils to a lower level so that it is a potential remedy that is presented after other potential remedies (e.g., check the refrigerant prior to cleaning the condensation coils).

Once the user is satisfied with the accuracy and/or completeness of the instruction, the user may transmit the instructions to a mobile device 110, which could be an augmented reality device, such as smart glasses, headset, and smart phone. In one embodiment, those instructions are transmitted to the mobile device 110 directly from the user's computing device 108. In alternate embodiments, the instructions are transmitted to the mobile device from the instructions system. Therefore, the user is provided with the content from the instructions system that can be overlayed (e.g., augmented) with the field of view of the user. In the case of the HVAC, the user can view the components of the HVAC and have digital content overlayed on the HVAC components to provide assistance with the task.

The mobile device can also align the content with the actual components being viewed. For example, if the user is looking at condensation coils, the mobile device can determine the orientation of the condensation coils and display content over the condensation coils such as a digital representation of the attachment points. Therefore, the user is provided with the location of certain aspects (e.g., attachment points) of the components that the user is viewing (e.g., condensation coils). This allows for an improved instructional content to be provided as the content is aligned with the physical components that are at the location of the user and are being viewed by the user.

In one embodiment, the user can be provided with a task order that can be transmitted to the second computer device or mobile device. The task order can include the task to be completed and additional information such as location and details about the task. For example, the task order may state that a customer reported that an HVAC system is not cooling, the location of the HVAC unit, the year, brand, make, model, repair history and the like. The work order can provide initial information to the user for the task to be completed.

Using the mobile device 110, the user may implement the instructions provided to complete the task at hand. The instructional system prompts the user to indicate when the task is complete and to complete a service report (e.g., complete the task order). When a task or subtask is completed, the user can indicate on the mobile device. The service report can be updated and may also include the user's feedback regarding the accuracy and/or effectiveness of the instructions provided by the instructional system. The instructional system can use the feedback provided to further update the information stored in database 106 and to further teach the artificial intelligence algorithm as to responses to inquiries for tasks from subsequent users.

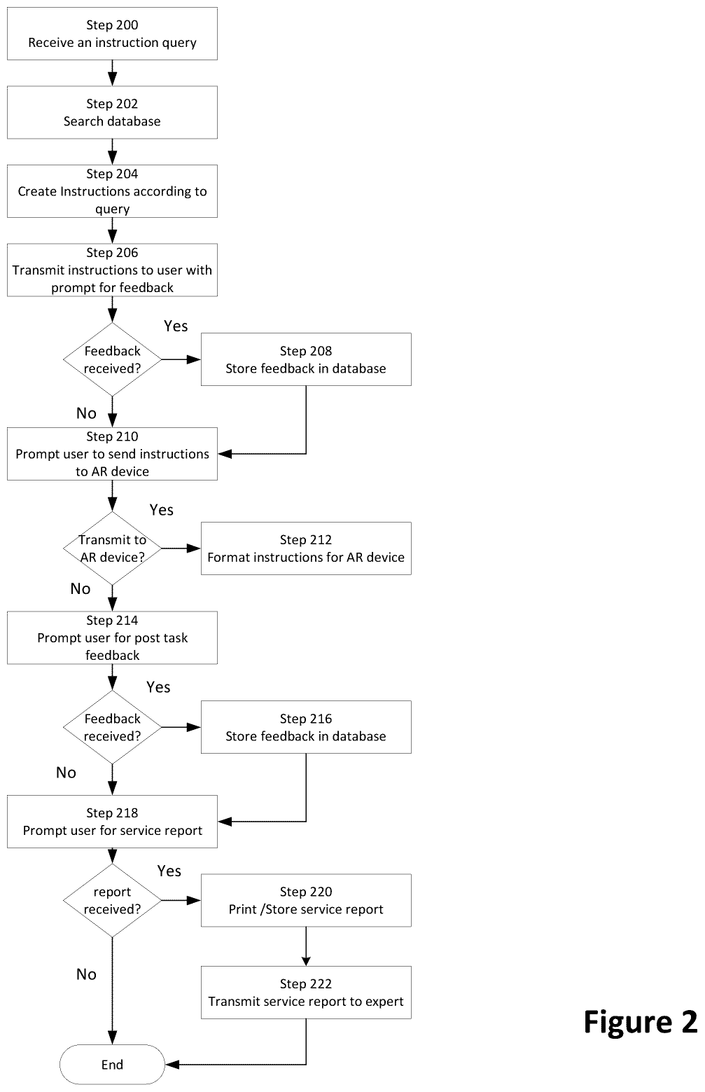

Referring now to FIGS. 1 and 2, the process by which the system is used by an end user is further detailed. At step 200, the instructional system receives a query for instructions on a task to be completed. At step 202 the instructional system performs a search of all information contained in the database according to the key terms and concepts of the query provided by the user. At step 204 the instructional system creates instructions based upon the results found. At step 206 the instructional system transmits instructions to the user's computing device along with a prompt for the user to review the instructions and provide any feedback. If the user provides feedback, the system saves any edits made as well as any feedback provided in the database at step 208. For example, the user may indicate that the content concerning condensation coils for a particular HVAC unit has connection points in a different area than that of the actual unit. In this case, the user can indicate that the information (e.g., content) being provided needs to be updated and send feedback accordingly. In one embodiment, the user feedback can be reviewed by an experienced technician.

At step 210, the system prompts the user to transmit instructions to an augmented reality device. If the user opts to transmit the instructions to such a device, the system formats the instructions for use on augmented reality device and transmits the formatted instructions at step 212. The user than is provided with the content specific to that task that can be visually overlayed on the actual components of the task to improve and assist with the accomplishment of the task.

Once the user is done performing the task, at step 214, the system prompts the user to provide post-task feedback regarding the accuracy and efficiency of the instructions and/or to provide any edits. If the user provides any feedback or edits, at step 216, the system saves the feedback in the database and can use the information to teach the Al algorithm and/or machine learning aspects to improve future instructions by incorporating the feedback into the training dataset for the Al algorithm and/or machine learning engine.

At step 218, the user can be prompted to create a service report detailing the date, time, etc. on which the task was completed, the manner, etc. in which it was completed and/or any other information or feedback the user chooses to include. If a service report is completed by the user, at step 220, the system prints and/or saves the service report to the user's account and can send the report to a remote server or other location. At step 222, the system may include the services report in a training dataset that can be used to further teach the Al algorithm and/or machine learning engine to modify future instructions.

If at step 202, the instructional system 100 is unable to find sufficient information within the database 106 to be able to create or predict instructions for completing the task to be completed, the instructional system will at step 203 suggest and/or make a call with a remote expert. In such case, the instructional system may use the instruction query received at step 200 to search the database for qualified experts and provide the user with a list of such experts from which to choose or in one embodiment, automatically place the user in communication with one or more of the experts revealed by the search. Alternatively, the instructions system may simply prompt the user to submit an expert search query with parameters for selecting an appropriate expert. The process of selecting and utilizing an expert is discussed more fully below. If, however, the instructional system can find sufficient information to be able to create or predict instruction for the task to be completed, such instructions are provided a step 204.

In some instances, instruction queries could comprise a request for technical documentation regarding a particular machine. In such a case, the instructional system would search the database at step 202 and if appropriate technical documentation exists, the documentation could be provided at step 204. Alternatively, the instructional system could create and/or predict technical documentation according to the search query at step 202 and provide that documentation at step 204. The document can be presented to the user by displaying it on the mobile device, on a smartphone and the like. Therefore, the user can have the documentation displayed on a handheld device for reference as well as on the mobile device so that the components of the task can be viewed simultaneously with the content. For example, the user may be able to see the components using a headset of smart glasses while having the content projected at or near these components so that the user is provided both.

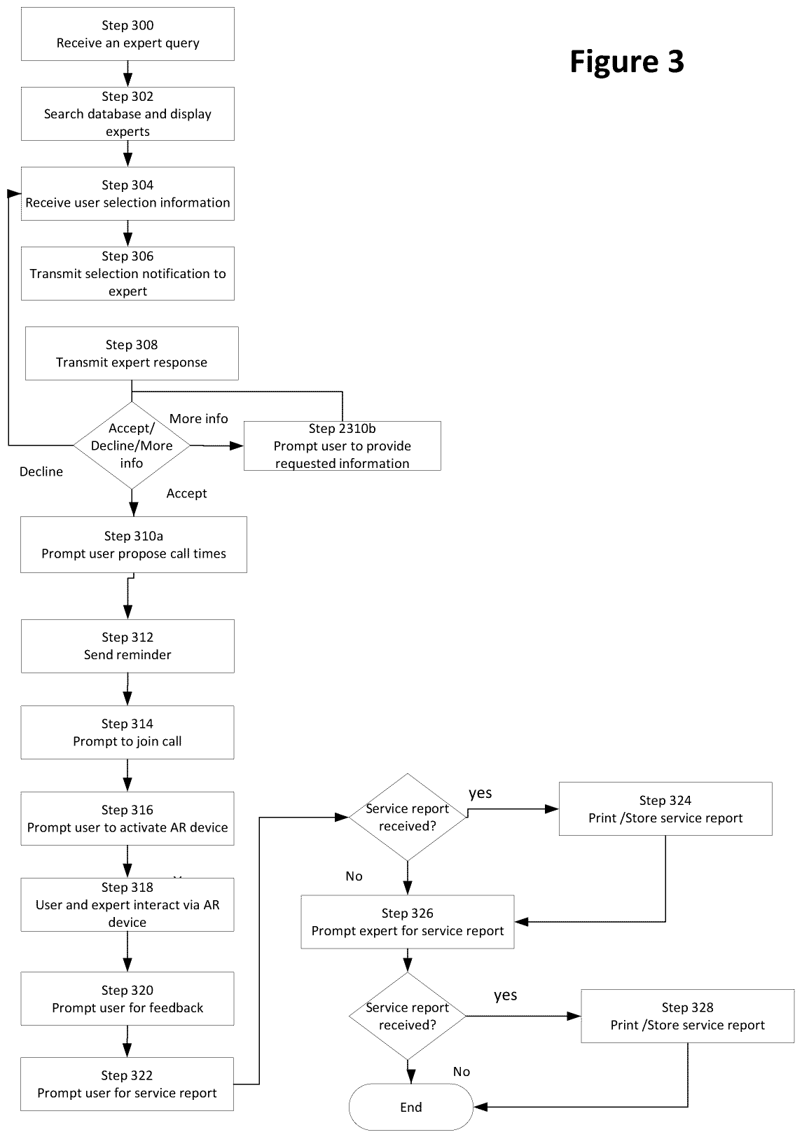

Referring now to FIGS. 1 and 3, the process in which the end user requests live help from an expert is described. In one embodiment, at step 300, using second computing device 108, the user enters a search query for an expert having knowledge and/or experience in a desired industry, field, task, and/or topic. At step 302, the instructions system displays expert information, representing information associated with an expert matching the user's search query, which can then be reviewed, sorted and/or filtered by the user. At step 304, instructional system 100 receives selection information representing the user's selection of a desired expert according to the expert information received. At step 306, the instructional system transmits a selection notification to the expert, representing an affirmative selection information received from user and the expert is given the option to accept or decline the selection notification or to seek more information from the user. At step 308, the expert's response is transmitted to the user. If the expert declines, the user is prompted to select another expert and/or to enter another search query. At step 310a, if the expert accepts the selection notification, the user is prompted to propose times for the service call. At step 310b, If the expert requests more information, the user is prompted to provide the requested information so that the expert may then accept or decline the engagement. At step 312, the instructional system sends reminders to both the user and the expert regarding the scheduled service call. At step 314, the instructions system prompts the user and expert to join the call at the scheduled time. At step 316, the user is prompted to activate the augmented reality device 110. At step 318, the expert may provide live instruction while the task is being completed and may see what the user sees and may augment the user's reality by pointing to, highlighting, circling items, providing readable instructions and/or diagrams and/or any other augmentations that are generally provided by augmented reality devices.

When the expert is connected to the user, the user's mobile device can transmit visual information from the mobile device to the expert's remote computer system. Therefore, the expert can see what the user is seeing. This can be accomplished with a smart phone or other device such as a headset with one or more cameras. The expert can notate the image that the expert sees such as by drawings on the image, adding content to the image or in proximity to the image, in a separate window and the like. This content is transmitted to the user and can be provided to the user through the mobile device. In one embodiment, the user is provided with the notations on the view so that the notations from the expert augment the view that the user is seeing. For example, if the user is viewing wiring, the image of the wiring can be transmitted to the expert. The expert can notate (e.g., draft a circle around or arrow to) a particular component such as a wire and the notation is displayed to the user so that the user can see which component (e.g., wire) the expert is discussing. Therefore, the communications ability between the user and a remote expert is greatly improved. Prior to or during the expert communication session, the instruction system and/or the user may transmit to the expert all previously provided instructions and/or technical documentation relating to the user's inquiry.

When the user and expert are communicating, this session may be recorded and the video and/or written transcription of the call may be stored in the database for purposes of teaching the artificial intelligence algorithm for purposes of creating and/or predicting instructions for the same or similar tasks to be completed in the future. This recording and/or the transcription thereof can also be used as source material that is provided in response to future search inquiries regarding tasks to be completed. At step 320, the instructions system prompts the user to provide feedback on the service call, including a rating of the expert's performance. At step 322, the instructions system prompts the user to create a service report detailing the date, time, etc. on which the task was completed, the manner, etc. in which it was completed and/or any other information or feedback the user chooses to include. At step 324, if a service report is created, it is saved to the user's account, and/or printed and/or provided to the expert. At step 326, the instructions system prompts the expert to create a service report including any information that the expert wishes to share. At step 328, if an expert service report is created, the service report is saved to the account of the expert and/or user, and/or printed and/or provided to the user.

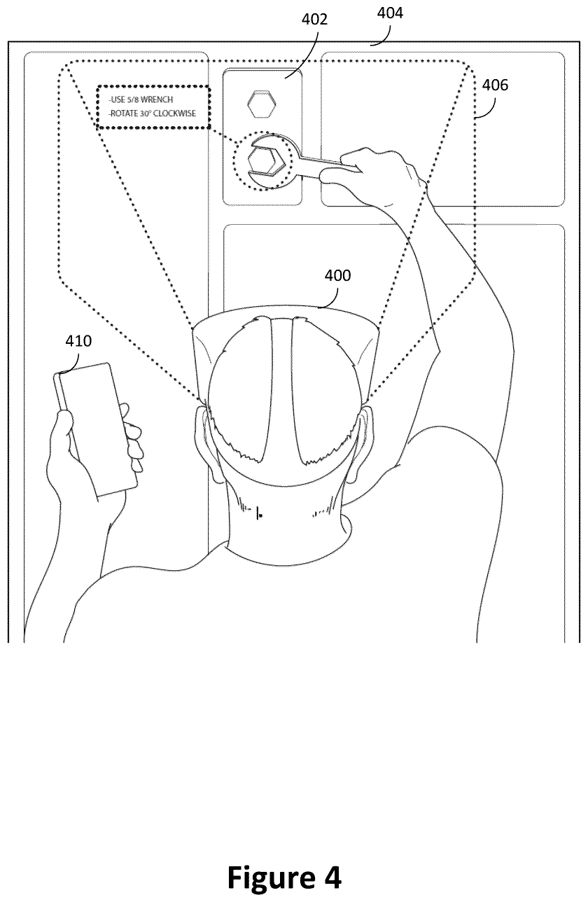

Referring to FIG. 4, the user is shown wearing a mobile device, a headset 400 in this illustration, that allows the user to see the components 402 that are included in a larger assembly 404 and as associated with a task. The headset can include cameras allowing the physical assembly and its components to be viewed by the user and to be augmented with digital images and content. The user can see the physical component as well as a projected digital image 406 using the mobile device. The digital image can overlay the physical view so that a notation 408 can be used to instruct the user to complete steps that are associated with the task. The user can also have a second mobile device 410 such as a smart phone that can display content to the user. The headset 400 and the smart phone 410 can be in communications so that the content can be displayed on either device when transmitted to one device. This feature also allows multiple users to assist with the performance of the task.

The mobile device (e.g., headset of mobile phone) can capture an image of the component associated with a task and transmit the task to an instructional system (FIG. 1, 100). The mobile devices can receive content associated with the task from the instructional system and display the content to the user for assistance with completing the task. The instructional system, as it is adapted to access a database that includes content associated with the task, can received component information from the mobile device in the format of text, images of video, receive task information and using this information, retrieve from the dataset an instruction for completing the task. The instructional system can then transmit the instruction to the mobile device. The user can perform the task and set a task status. The task status can include “completed”, “incomplete”, “attempted” and any combination. According to the task status, a task order can be closed (e.g., complete) or open (e.g., incomplete) and the task order can be transmitted or stored on the instructional system or other system such as a work order system that can be in communication with the mobile device, instructional system or both.

In the event that user needs assistance with the performance of the task and the content that is provided from the instructional system is inadequate, the instructional system can automatically or upon the user's request, establish a connection with a remote computer system according to a task that has been attempted but is incomplete (e.g., one with the task status being “attempted-incomplete”). The remote computer system (FIG. 1, 102) can be in communication with the mobile device and can be adapted to receive the image from the mobile device, display the image, receive a notation to the image, transmit the notation to the mobile device. In at least one embodiment, the expert may use the remote computer device to communicate with the user as described herein.

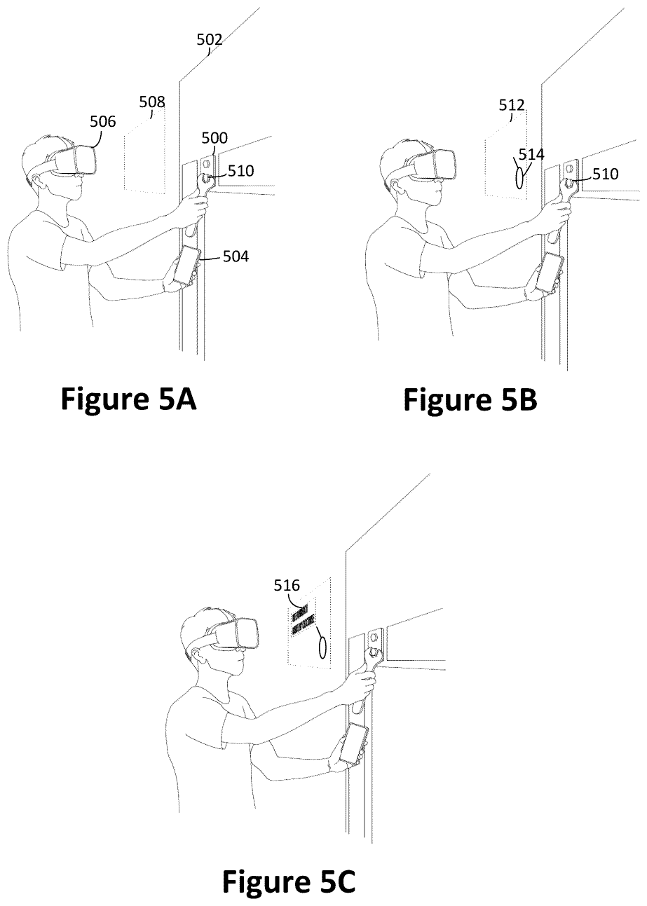

Referring to FIG. 5A, the user is attempting to perform a task that involves component 500 of assembly 502. Content from the instructional system can be displayed on a second mobile device 504, however, the user is unable to complete the task with the provided information. The instructional system can provide the user with real-time assistance by using a technical expert that can connect to the mobile device 504 or headset 506. A remote computer device (FIG. 1, 102) can connect to the headset or smart phone and allow communications between the expert and the user. The smart phone or headset can capture image of video in a field of view 508 that can be transmitted to the remote computer device and the technical expert allowing the expert to see what the user is seeing.

Referring to FIG. 5B, the technical expert can provide a notation on the remote computer device screen that can identify a component or step associated with the task. For example, the technical expert can identify component 510 by circling the component with a notation 514 virtually on the remote computer screen that can be transmitted to the project view 512 which can overlay the physical component 510. Therefore, the technical expert can assist the user with the task. Referring to FIG. 5C, if the user is still unable to complete the task or needs clarification on the task, the technical expert can provide additional content such as text, images, or video 516 that can be transmitted to the mobile device (e.g., headset, mobile phone, smart phone and the like). Therefore, the user can view the content 516 and the physical component in a composite actual and digital image to assist with completion of the task. The user can see that the expert sees and vice versa.

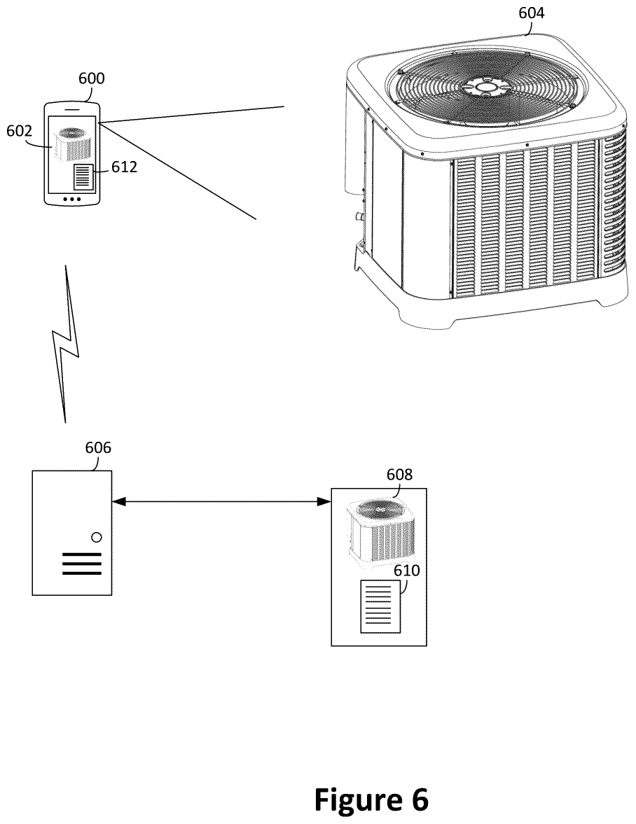

Referring to FIG. 6, and in one embodiment, the mobile device 600 can transmit an image 602 of the component and/or assembly 604 to the instructional system 606. The instructional system can be adapted to determine component attributes according to the image by using the received image 602 and searching the dataset for a corresponding image 608. Using image matching, such as vector analysis, the instructional system can search the dataset and determine if there is a matching image and if so, provide the user the make, model and other information 610. The mobile device can be adapted to capture component and/or assembly information and transmit the component and/or assembly information to the instructional system the instructional system is adapted to determine component attributes according to the component information. The mobile device can then display the content 612 on the mobile device adjacent to a view of the component from the mobile device. The content can be displayed in a composite actual and digital view as shown in FIG. 4.

The system can include a first mobile device such as a headset and a second mobile device such as a smart phone wherein both can be adapted to display the content from the instructional system. The mobile device can be adapted to stream video of a component and/or assembly associated with a task, transmit the video to the instructional system, receive content associated with the task from the instructional system and display the content on the mobile device. The instructional system can be adapted to establish a connection with a remote computer device used by a technical expert, for example, when the task status is “attempted-incomplete” indicating that the user needs additional information for task completion. The exert can use a remote computer system in communications with the mobile device and the remote computer system can be adapted to receive video from the mobile device, derive an image from the video, receive a notation to the image, transmit the notation and image to the mobile device. The notation can be a real time dynamic notation, and the mobile device is adapted to display the real time dynamic notation in close proximity to the component associated with the task. Because the user and the expert can view the same or similar composite image (e.g., physical component and digital overlays) the expert can provide notations to the user in real time.

In one embodiment, the instructional system can be adapted to determine component attributes according to the video. For example, when the instructional system receives an image of the assembly, the instructional system can search the database, retrieve the like image thereby identifying the assembly and provide information and attributes such as shown in Table 1.

In one embodiment, the instructional system can be adapted to receive feedback directed to the content, determine a modification to the content and modify the content thereby providing subsequent users with modified content. In this embodiment, the user can provide feedback such as “helpful”, “not helpful” and the like. The instructional system can then modify content attributes with feedback for subsequent users. For example, if content is deemed not helpful by one or more user, the content can be assigned a lower priority for display, modified, transmitted to a operator for review and potential modification of deleted. This feature can be helpful when the content on the instructional system is provided by multiple experts and even when the content is provide through crowd sourcing.

The mobile device can provide a video stream of the component associated with a task, transmit the video to the instructional system, receive content associated with the task from the instructional system and display the content on the mobile device in proximity to the component in combination with a view of the component. The instructional system can be adapted to receive the task, access a dataset that includes content associated with the task, determine component information from the mobile device, retrieve from the dataset an instruction for completing the task, transmitting the instruction to the mobile device, receiving a task status, completing a task order according to the task status being complete. The instructional system can be adapted to modify the content according to the task status associated with the task. The mobile device can be adapted to transmit notes to the instructional system and the instructional system is adapted to modify the content according to the notes.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For purposes of this invention, a computing device can include desktops, laptops, mobile devices or the like. Each computing device can include one or more processors and one or more non-transitory computer-readable media that collectively store instructions that, when executed by the one or more processors, cause the device to perform operations. The computing devices can be connected by a network such as a local area network, wide area network, the Internet, secure network, cellular network, mesh network, peer to peer and any combination thereof.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention.

While the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiment described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A physical and virtual task support and assistance system comprising:
a mobile device adapted to capture an image of a component associated with a task, transmit the task to an instructional system, receive content associated with the task from the instructional system and display the content on the mobile device;
wherein the instructional system is adapted to access a database that includes content associated with the task, receive component information, receive task information, retrieve from the database an instruction for completing the task, transmit the instruction to the mobile device, receive a task status, complete a task order according to the task status being complete, establish a connection with a remote computer system according to a task status being attempted-incomplete; and,
wherein the remote computer system is in communications with the mobile device and adapted to receive the image from the mobile device, display the image, receive a notation to the image, and transmit the notation to the mobile device.

2. The system of claim 1 wherein the instructional system is adapted to determine component attributes according to the image.

3. The system of claim 1 wherein:
the mobile device is adapted to capture component information and transmit the component information to the instructional system; and,
the instructional system is adapted to determine component attributes according to the component information.

4. The system of claim 3 wherein the component information is a component information image.

5. The system of claim 1 wherein the mobile device is adapted to display the content on the mobile device adjacent to a view of the component from the mobile device.

6. The system of claim 1 wherein the mobile device is a first mobile device and a second mobile device adapted to display the content from the instructional system.

7. A physical and virtual task support and assistance system comprising:
a mobile device adapted to stream video of a component associated with a task, transmit the video to an instructional system, receive content associated with the task from the instructional system and display the content on the mobile device; and,
wherein the instructional system is adapted to receive the task, access a database that includes content associated with the task, determine component information from the received video, retrieve from the database an instruction for completing the task, transmitting the instruction to the mobile device, receiving a task status, completing a task order according to the task status being complete.

8. The system of claim 7 wherein the instructional system is adapted to establish a connection with a remove computer device according to a task status being attempted-incomplete; and,
a remote computer system in communications with the mobile device and adapted to receive the video from the mobile device, derive an image from the video, receive a notation to the image, transmit the notation and image to the mobile device.

9. The system of claim 8 wherein the notation is a real time dynamic notation, and the mobile device is adapted to display the real time dynamic notation is in close proximity to the component associated with the task.

10. The system of claim 9 wherein the notation is a real time dynamic notation and overlayed with a view of the component associated with the task.

11. The system of claim 7 wherein the instructional system is adapted to determine component attributes according to the video.

12. The system of claim 7 wherein the instructional system is adapted to receive feedback directed to the content, determine a modification to the content and modify the content thereby providing subsequent users with modified content.

13. The system of claim 7 wherein the mobile device is a first mobile device and a second mobile device adapted to display the content from the instructional system.

14. A physical and virtual task support and assistance system comprising:
a mobile device adapted to stream video of a component associated with a task, transmit the video to an instructional system, receive content associated with the task from the instructional system and display the content on the mobile device in proximity to the component in combination with a view of the component; and,
wherein the instructional system is adapted to receive the task, access a database that includes content associated with the task, determine component information from the mobile device, retrieve from the database an instruction for completing the task, transmitting the instruction to the mobile device, receiving a task status, completing a task order according to the task status being complete.

15. The system of claim 14 wherein a remote computer system is in communication with the mobile device and adapted to receive the video from the mobile device, display the video, receive a notation to the video, transmit the notation to the mobile device.

16. The system of claim 15 wherein the notation is a real time dynamic notation and is overlayed with a view of the component associated with the task.

17. The system of claim 14 wherein the mobile device is a first mobile device and a second mobile device adapted to display the content from the instructional system.

18. The system of claim 14 wherein the mobile device is adapted to set the task status to complete, and the instructional system is adapted to receive the task status.

19. The system of claim 18 wherein the instructional system is adapted to modify the content according to the task status associated with the task.

20. The system of claim 14 wherein the mobile device is adapted to transmit notes to the instructional system and the instructional system is adapted to modify the content according to the notes.
